(19) United States
(12) Patent Application Publication
(10) Pub. No.: US 2009/0164945 A1
(43) Pub. Date: Jun. 25, 2009

(54) INFORMATION PROCESSING DEVICE AND INTEGRATED INFORMATION SYSTEM

(76) Inventor: Yan Li, Beijing (CN)

Correspondence Address: Patrick W. Rasche;Armstrong Teasdale LLP, Suite 2600, One Metropolitan Square, St. Louis, MO, 63102, US

(21) Appl. No.: 12/337,489

(22) Filed: Dec. 17, 2008

(30) Foreign Application Priority Data
Dec. 21, 2007 (CN) 200710162174.8

(51) Int. Cl. G06F 3/048

(52) U.S. Cl. 715/849

(57) ABSTRACT

An information processing device and integrated information system in which many resources are accessible by a simple, clear user interface are provided. The information processing device includes a use interface including displayed faces of a 3D polyhedron icon used to select information to be executed from multiple pieces of information. The multiple pieces of information are allocated to the faces. The 3D polyhedron icon is a parallelepiped for example. By rotating the 3D polyhedron icon horizontally and vertically, a face to be displayed can be switched. The user interface displays an index showing the rotational direction of the 3D polyhedron icon.

### CROSS REFERENCE TO RELATED APPLICATIONS

This application claims the benefit of Chinese Patent Application No. 200710162174.8 filed Dec. 21, 2007, which is hereby incorporated by reference in its entirety.

### BACKGROUND OF THE INVENTION

The subject matter disclosed herein relates to an information processing device and information processing method for selecting and executing accesses to resources of, e.g., an information system by a user by use of a user interface displayed on a display.

In the information system, the user receives a desired service by accessing various resources of a server via a terminal. The accesses to the resources are done by use of the user interface. The user interface is displayed in the display of a terminal as graphical icons, which are operable by, e.g., a pointing device (for example, see Japanese Unexamined Patent Publication No 2003-223597).

To display multiple resources in one screen, a tab user interface is used. This user interface simulates a tab of a folder of paper documents. Resources are allocated to tabs, respectively. By making a desired tab active by use of, e.g., a pointing device, a target resource can be accessed. In other words, the tab functions as a button for selecting a resource (for example, see Japanese Unexamined Patent Publication No 2005-7881).

### BRIEF DESCRIPTION OF THE INVENTION

In the above interface, as resources increase in number, tabs or buttons increase in number, complicating the screen. Since resources and tabs which can be displayed in one screen are limited in number, accessible resources are limited in number.

The embodiments described herein provide an information processing device and integrate information system in which many resources are accessible by a simple, clear user interface.

According to a first aspect, an information processing device comprises a user interface including displayed faces of a 3D polyhedron icon for selecting information to be executed from a plurality of pieces of information, wherein the plurality of pieces of information being allocated to the faces.

According to a second aspect, in the information processing device of the first aspect, the 3D polyhedron icon is a parallelepiped.

According to a third aspect, in the information processing device of the first aspect, the faces of the 3D polyhedron icon can be switched and displayed by horizontal and vertical rotations.

According to a forth aspect, in the information processing device of the third aspect, the user interface includes displayed indicator showing a rotational direction of the 3D polyhedron icon.

According to a fifth aspect, in the information processing device of the third aspect, the 3D polyhedron icon is rotated by keyboard operation. According to a sixth aspect, in the information processing device of the first aspect, the user interface comprises: a first screen for displaying icons of information systems whose types are selectable using the icons; a second screen for displaying icons of a plurality of subsystems which are contained in each of the information systems and whose types are selectable using the icons of the subsystems when each of the information systems is selected in the first screen; and a third screen for displaying the 3D polyhedron icon in which a plurality of pieces of information in each of the subsystems are selectable when each of the subsystems is selected in the second screen.

According to a seventh aspect, in the information processing device of the sixth aspect, the types of the information systems are selected by keyboard operation in the first screen.

According to an eighth aspect, in the information processing device of the sixth aspect, the types of the information systems are selected by keyboard operation in the second screen.

According to a ninth aspect, in the information processing device of the sixth aspect, the information systems are medical image information systems. According to a tenth aspect, an integrated information system comprises: a server; and a client device which can communicate with the server. The client device is able to access resources of a plurality of information systems of the server in the integrated information system. The client device includes an information processing device having a user interface including displayed faces of a 3D polyhedron icon for selecting information to be executed from a plurality of pieces of information, wherein the plurality of pieces of information being allocated to the faces.

According to an eleventh aspect, in the integrated information system of the tenth aspect, the 3D polyhedron icon is a parallelepiped. According to a twelfth aspect, in the integrated information system of the tenth aspect, faces of the 3D polyhedron icon can be switched and displayed by horizontal and vertical rotations.

According to a thirteenth aspect, in the integrated information system of the twelfth aspect, the user interface includes displayed indicator showing a rotational direction of the 3D polyhedron icon.

According to a fourteenth aspect, in the integrated information system of the twelfth aspect, the 3D polyhedron icon is rotated by keyboard operation. According to a fifteenth aspect, in the integrated information system of the tenth aspect, the user interface comprises: a first screen for displaying icons of information systems whose types are selectable using the icons; a second screen for displaying icons of a plurality of subsystems which are contained in each of the information systems and whose types are selectable using the icons of the subsystems when each of the information systems is selected in the first screen; and a third screen for displaying the 3D polyhedron icon in which a plurality of pieces of information in each of the subsystems are selectable when each of the subsystems is selected in the second screen.

According to a sixteenth aspect, in the integrated information system of the fifteen aspect, the types of the information systems are selected by keyboard operation in the first screen.

According to a seventeenth aspect, in the integrated information system of the fifteen aspect, the types of the information systems are selected by keyboard operation in the second screen.

According to an eighteenth aspect, in the integrated information system of the tenth aspect, the information systems are medical image information systems.

According to the first aspect, an information processing device comprises a user interface including displayed faces of a 3D polyhedron icon for selecting information to be executed from a plurality of pieces of information, wherein the plurality of pieces of information being allocated to the faces. Accordingly, many resources are accessible by a simple, clear user interface.

According to the tenth aspect, an integrated information system comprises: a server; and a client device which can communicate with the server. The client device is able to access resources of a plurality of information systems of the server in the integrated information system. The client device includes a user interface for displaying a face of a 3D polyhedron icon used to select information to be executed from a plurality of pieces of information, the information to be executed being allocated to the face. Accordingly, many resources are accessible by a simple, clear user interface.

According to the second or eleventh aspect, the 3D polyhedron icon is a parallelepiped. Accordingly, the 3D polyhedron icon is more aesthetic than 2D display tabs and buttons.

According to the third or twelfth aspect, the faces of the 3D polyhedron icon can be switched and displayed by horizontal and vertical rotations. Accordingly, the operational feeling is comfortable.

According to the forth or thirteenth aspect, the user interface displays an indicator showing a rotational direction of the 3D polyhedron icon. Accordingly, the operability is excellent.

According to the fifth or fourteenth aspect, the 3D polyhedron icon is rotated by keyboard operation. Accordingly, the operation is easy.

According to the sixth or fifteenth aspect, the user interface comprises: a first screen for displaying icons of information systems whose types are selectable using the icons; a second screen for displaying icons of a plurality of subsystems which are contained in each of the information systems and whose types are selectable in the second screen when each of the information systems is selected in the first screen; and a third screen for displaying the 3D polyhedron icon in which a plurality of pieces of information in each of the subsystems are selectable when each of the subsystems is selected in the second screen. Accordingly, multiple step selection is possible.

According to the seventh or sixteenth aspect, the types of the information systems are selected by keyboard operation in the first screen. Accordingly, the operation is easy.

According to the eighth or seventeenth aspect the types of the information systems are selected by keyboard operation in the second screen. Accordingly, the operation is easy.

According to the ninth or eighteenth aspect, the information systems are medical image information systems. Accordingly, a medical information system in which many resources are accessible by a simple, clear interface can be provided.

### BRIEF DESCRIPTION OF THE DRAWINGS

FIG. 1 shows a system structure of an exemplary integrated information system;

FIG. 2 shows one example of a user interface;

FIG. 3 shows one example of the use interface;

FIG. 4 shows one example of a 3D polyhedron icon; and

FIG. 5 shows one example of rotation of the 3D polyhedron icon.

### DETAILED DESCRIPTION OF THE INVENTION

Various embodiments of the invention are explained below in reference to the drawings. However, the invention is not limited by the embodiments described herein.

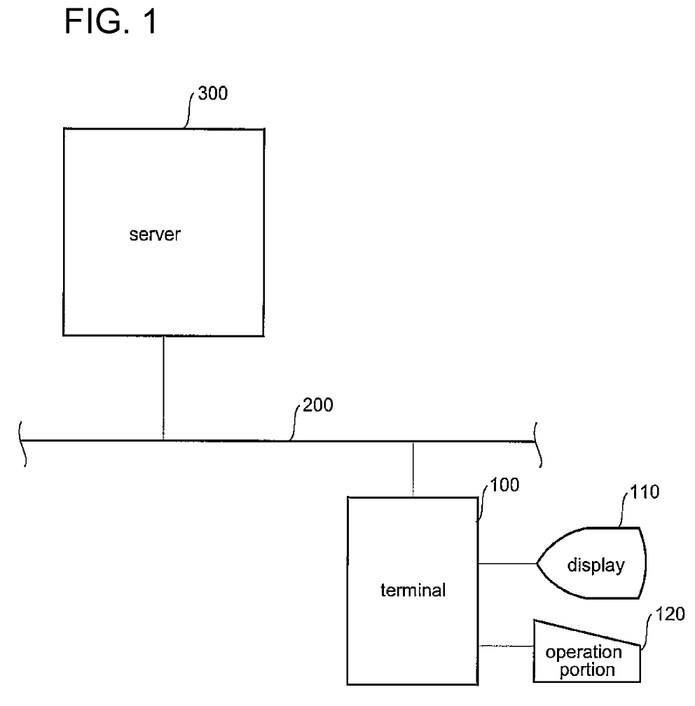

FIG. 1 shows a schematic structure of an integrated information system. As shown in FIG. 1, the system has a terminal 100. The terminal 100 has a display 110 and a operation portion 120. The display 110 has a graphic display. The operation portion 120 has a keyboard and a pointing device, so that the after-mentioned user interface displayed in the display 110 can be operated.

The terminal 100 is connected to a network 200. Other multiple terminals can reside in the network 200, but are represented by one terminal. A server 300 resides in the network 200. The server 300 provides a requested service to the terminal 100. Multiple servers 300 can reside in the network 200, but are represented by one terminal.

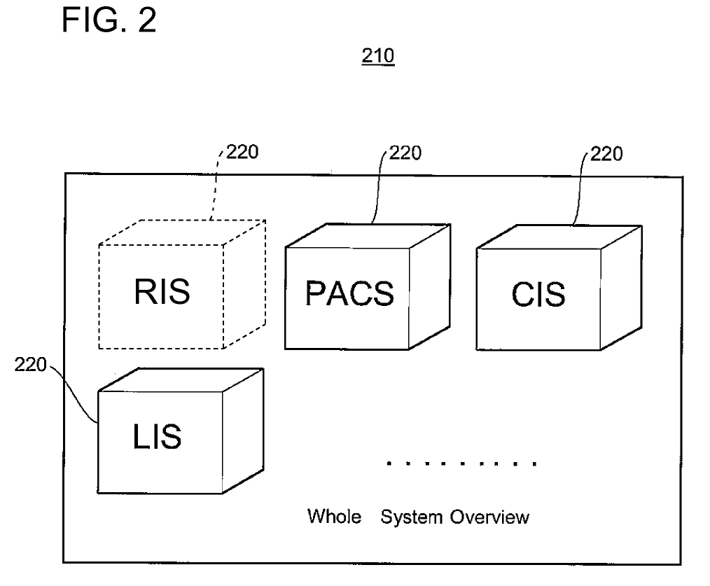

An access from the terminal 100 to a resource of the server 300 is explained. FIG. 2 shows one example of the user interface used for the access. As shown in FIG. 2, the user interface 210 has a 3D parallelepiped. A name of a resource system is displayed on a front face of the parallelepiped.

An example in which four icons 220 are displayed on one screen is shown here. The four icons 220 correspond to four resource systems, respectively. For example, the four resource systems include the RIS (Radiology Information System), the PACS (Picture Archiving and Communication System), the CIS (Clinical Information System), and the LIS (Laboratory Information System).

These resource systems are alternatively selectable by, e.g., the pointing device. When one of the resource systems is selected, resource systems subordinate to the selected system are displayed. The subordinate resource systems are also displayed on the parallelepiped icons 220.

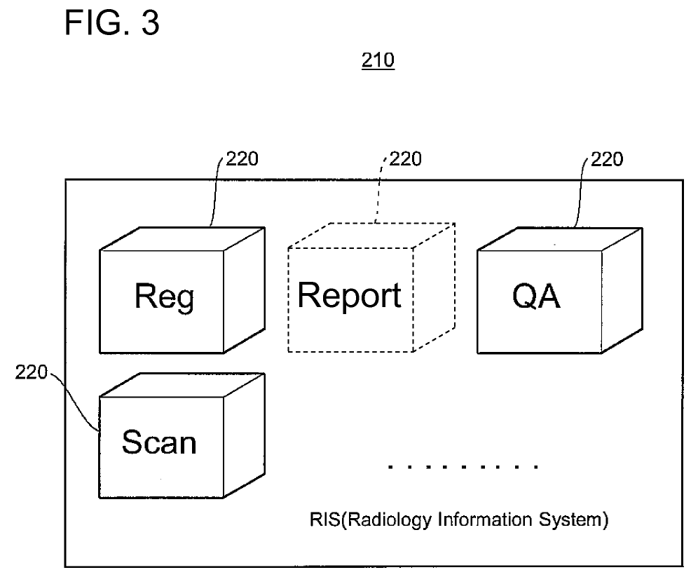

For example, as shown in FIG. 3, when the RIS is selected, resource systems subordinate to the RIS are shown by the multiple 3D display parallelepipeds. The multiple parallelepipeds are displayed on one screen. Names of the resource systems are shown on the front faces of the parallelepipeds.

These resource systems are multiple subsystems forming the RIS. For example, the multiple subsystems forming the RIS are the Reg (Registration workstation), the Report (Report workstation), the QA (Quality Assurance workstation), and the Scan (Scan workstation).

These resource systems are also alternatively selectable by, e.g., the pointing device. When one of the resource systems is selected, resources subordinate to the selected resource system are displayed. The resources are displayed on the parallelepiped icons 220.

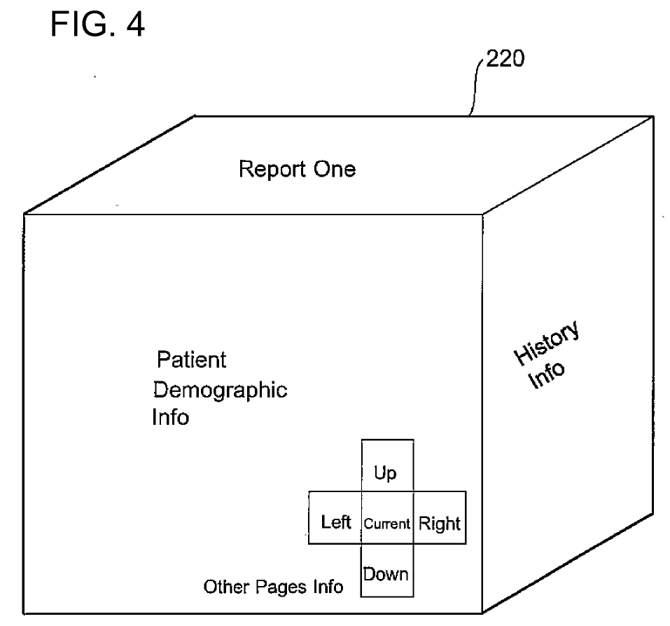

For example, when the Report is selected, resources belonging to the Report are displayed on the 3D display parallelepiped, as shown in FIG. 4. These resources are the lowest resources, and the parallelepiped is displayed alone. The parallelepiped is enlarged alone on the full screen.

Names of the lowest resources are displayed on faces of the parallelepiped of the icon 220, respectively. The resource names show the resources allocated to the faces, respectively. The Patient Demographic Information is allocated to the front face, the Report one is allocated to the top face, and the History Information is allocated to the right side face. Other resources are allocated to the other faces, but hidden behind.

Only the access to the resource displayed on the front face of the parallelepiped is possible. In other words, for example, in the situation shown in FIG. 4, when the keyboard operation “enter” is executed, the Patient Demographic Information is selected and accessed, and then is served from the server 300 to the terminal 100. The access is also possible by clicking the front face of the parallelepiped by use of the pointing device instead of the keyboard operation “enter.”

This icon 220 can rotate in the two directions. The two rotational directions are the horizontal direction (Right, Left) and the vertical direction (Up, Down), as shown in the four quadrates cross arranged at the bottom right of the front face of the icon 220.

The icon 220 is rotated by, e.g., the keyboard operations “control+→,” “control+←,” “control+⇑,” and “control+↓.” Instead of the keyboard operations, one of the cross arranged quadrates may be clicked by the pointing device.

By rotating the icon 220 by use of this function, the face to which a desired resource is allocated can face front. In this situation, by the keyboard operation “enter” or by clicking the front face of the parallelepiped, the access to the desired resource becomes possible.

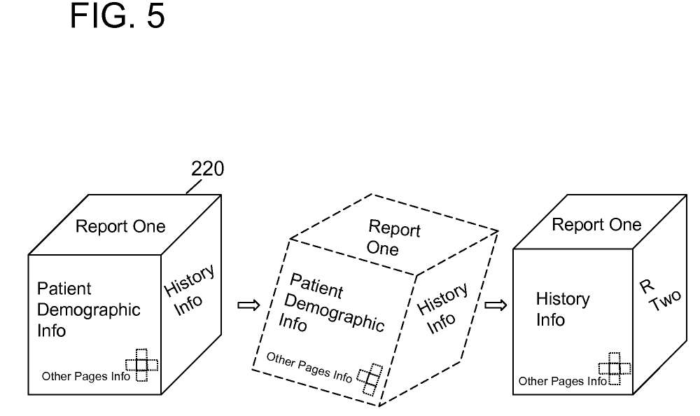

FIG. 5 shows one example of the rotation of the icon 220. For example, as shown in FIG. 5, to access the History Information allocated to the right side face, the right side face faces front by rotating the icon 220 right. Accordingly, since the History Information faces front, the access to the History Information becomes possible by the keyboard operation or clicking.

When the History Information faces front, the resource Report Two, hidden until now, appears on the right side face. To access the resource Report Two, the Report Two may be directed front by further right rotation.

When the Report Two faces front, another resource, hidden until then, appears on the right side face. To access the another resource, this resource faces front by right rotation. To access further resources, the same operations are executed.

The number of the resources sequentially switching by right rotation is unrelated to the number of vertical faces of the parallelepiped. In other words, the number of vertical faces of the parallelepiped is four, but the number of switchable resources is not limited to four, and can be therefore over four.

When the last resource faces front, the right side face becomes blank. Accordingly, a user can recognize that the last of the resource arrangement has been reached. The resource arrangement may be endless. In this case, by displaying the first resource, the completion of one loop of the resources is shown.

The above explanation is about the example in which the icon 220 is rotated right. The same operation as the above explanation is possible by left rotation. The same operation is also possible by upward and downward rotations. Further, the above explanation is about the example of the parallelepiped icons. Other 3D polyhedrons may be used.

1. An information processing device comprising a user interface comprising a plurality of displayed faces of a 3D polyhedron icon for selecting information to be executed based one a plurality of pieces of information, wherein each of the plurality of pieces of information is allocated to a corresponding face of the plurality of displayed faces.

2. The information processing device according to claim 1, wherein the 3D polyhedron icon is a parallelepiped.

3. The information processing device according to claim 1, wherein the plurality of displayed faces of the 3D polyhedron icon can be switched and displayed by horizontal and vertical rotations.

4. The information processing device according to claim 3, wherein said user interface further comprises a displayed indicator showing a rotational direction of the 3D polyhedron icon.

5. The information processing device according to claim 3, wherein the 3D polyhedron icon is rotated by keyboard operation.

6. The information processing device according to claim 1, wherein said user interface further comprises:
a first screen configured to display icons of a plurality of information systems whose types are selectable using the icons;
a second screen configured to display icons of a plurality of subsystems which are contained in each of the plurality of information systems and whose types are selectable using the icons of the subsystems when a desired information system of the plurality of information systems is selected in said first screen; and
a third screen configured to display the 3D polyhedron icon in which the plurality of pieces of information in each of the plurality of subsystems are selectable when a desired subsystem of the plurality of subsystems is selected in said second screen.

7. The information processing device according to claim 6, wherein the types of the information systems are selected by keyboard operation in said first screen.

8. The information processing device according to claim 6, wherein the types of the subsystems are selected by keyboard operation in said second screen.

9. The information processing device according to claim 6, wherein the plurality of information systems are medical image information systems.

10. An integrated information system comprising:
a server; and
a client device configured to communicate with said server over a network, said client device further configured to access resources of a plurality of information systems of said server in said integrated information system, said client device comprising an information processing device comprising a user interface comprising a plurality of displayed faces of a 3D polyhedron icon for selecting information to be executed based on a plurality of pieces of information, wherein each of the plurality of pieces of information is allocated to a corresponding face of the plurality of displayed faces.

11. The integrated information system according to claim 10, wherein the 3D polyhedron icon is a parallelepiped.

12. The integrated information system according to claim 10, wherein the plurality of displayed faces of the 3D polyhedron icon can be switched and displayed by horizontal and vertical rotations.

13. The integrated information system according to claim 12, wherein said user interface further comprises a displayed indicator showing a rotational direction of the 3D polyhedron icon.

14. The integrated information system according to claim 12, wherein the 3D polyhedron icon is rotated by keyboard operation.

15. The integrated information system according to claim 10, wherein said user interface further comprises:
a first screen configured to display icons of the plurality of information systems whose types are selectable using the icons;
a second screen configured to display icons of a plurality of subsystems which are contained in each of the plurality of information systems and whose types are selectable using the icons of the subsystems when a desired information system of the plurality of information systems is selected in said first screen; and
a third screen configured to display the 3D polyhedron icon in which the plurality of pieces of information in each of the plurality of subsystems are selectable when a desired subsystem of the plurality of subsystems is selected in said second screen.

16. The integrated information system according to claim 15, wherein the types of the information systems are selected by keyboard operation in said first screen.

17. The integrated information system according to claim 15, wherein the types of the information systems are selected by keyboard operation in said second screen.

18. The integrated information system according to claim 15, wherein the plurality of information systems are medical image information systems.

19. An information processing method comprising:
displaying a plurality of faces of a 3D polyhedron icon within a user interface of a client device coupled to a server over a network;
selecting, at the client device, information to be executed by the server based on a plurality of pieces of information, each of the plurality of pieces of information being allocated to a corresponding face of the plurality of faces; and
executing the selected information at the server.

20. The information processing method according to claim 19, further comprising switching the plurality of faces of the 3D polyhedron icon in horizontal and vertical directions using the client device.
